(19) United States
(12) Patent Application Publication
(10) Pub. No.: US 2017/0260431 A1
(43) Pub. Date: Sep. 14, 2017

(54) ADHESION-MODIFIED OLEFINIC THERMOPLASTIC ELASTOMERS, IN PARTICULAR TPE-V, TPE-O

(71) Applicant: ALBIS PLASTIC GMBH, Hamburg (DE)

(72) Inventors: Jörg FRAHN, Lilienthal (DE); Nick LICHTENAUER, Pinneberg (DE)

(73) Assignee: ALBIS PLASTIC GMBH, Hamburg (DE)

(21) Appl. No.: 15/508,813

(22) PCT Filed: Sep. 9, 2015
(86) PCT No.: PCT/EP2015/070609

§ 371 Date: Mar. 3, 2017

(30) Foreign Application Priority Data
Sep. 11, 2014 (DE) 10 2014 218 260

(51) Int. Cl. C09J 123/16; C08L 23/16; C09J 123/12; C08L 23/12

(52) U.S. Cl. CPC C09J 123/16; C08L 23/12; C08L 23/16; C09J 123/12; C08L 2205/02; C08L 2205/035; C08L 2207/04

(57) ABSTRACT

An olefinic thermoplastic elastomer composition comprising a rubber component and a polyolefin, characterised in that the composition further comprises an adhesion promoter system which in turn comprises one or more first adhesion promoters from the group of wetting adhesion promoters and one or more second adhesion promoters from the group of chemically reactive adhesion promoters.

The present invention relates to adhesion-modified thermoplastic elastomers, specifically olefinic TPE-Vs and TPE-Os.

Thermoplastic elastomers (TPE) are materials in which elastic polymer chains are integrated in thermoplastic material and convey their rubber-elastic properties. As a result of physical cross-links which are present in portions and can be broken by heat, the material properties of thermoplastic elastomers vary over time and temperature in a non-linear manner. TPEs are non-polar and are categorised as block copolymers and elastomer alloys according to their inner structure.

Block copolymers have hard and soft segments inside one molecule. The plastics material therefore consists of one type of molecule in which the two properties are distributed. Examples of block copolymers include SBS, SIS or TPE-U.

By contrast, elastomer alloys are polymer blends, i.e. mixtures of final polymers. The finished plastics material therefore consists of a plurality of different types of molecules. By selecting suitable mixture ratios and types and amounts of loading materials, it is possible to obtain purpose-made materials which cover a wide hardness range. Olefinic TPEs are of particular interest for the invention, specifically vulcanisable TPE-Vs primarily, but also non-vulcanisable TPE-Os, preferably TPEs of these kinds that are based on PP/EPDM.

In engineering, it is often desired to adhesively coat polar substrates with TPEs or produce sandwich structures in this manner.

Adhesion is understood in this case to mean a phenomenon between two substrates which is based on intermolecular interactions at the solid-solid interfaces and emerges so as to counter a separating stress. Adhesion may also be referred to as a state in which two surfaces are held together by valence forces and/or mechanical anchorage. Adhesion by mechanical anchorage can be attained by roughening, undercutting, or generally by means of a positive or non-positive connection. Adhesion by predominantly physical bonding can be attained by electrical attraction such as by Van der Waals interactions or hydrogen bridge bonds. Adhesion by integral bonding can be attained by chemical bonds, in particular by forming covalent bonds between the polar substrate to be coated and the applied adhesive or the applied TPE.

Thus far, it has been difficult to adhere polar substrates, such as glass, metals, steel, polyamides, thermoplastic resins, inorganic base materials, etc. to TPE; it has been particularly difficult to do this using conventional and desired methods such as compression moulding, co-moulding, overmoulding, co-extrusion or injection moulding.

In order to generate adhesion, it was known to a greater extent to treat the substrate surface to be coated by means of roughening using etchants, flame treatment, ozone and the like. However, treating the surface in this way results in significant product deterioration and requires an additional manufacture step. For example, DE 10 2007 023 418 A1 discloses roughening and DE 10 2009 051 717 A1 discloses roughening by plasma treatment.

In order to generate adhesion, it was also known to apply a coating to the substrate before subsequently coating said substrate with TPE. These adhesion-promoting coatings also have to be applied to the substrate in a separate processing step and have to be subsequently dried or cured, and this is unfavourable.

In order to generate adhesion, it was also known to provide adhesive thermoplastic elastomer compositions with grafted maleic anhydride polypropylene (MAH-PP) such that the MAH-PP introduced a certain degree of polarity into the elastomer compositions. In this case, however, the resulting total hardness can increase such that, in order to obtain the low original hardness of the TPE, further additives, such as block copolymers consisting of styrene/conjugated diene/styrene had to be added (WO 95/26380 A1).

Finally, DE 698 03 448T2 discloses a TPE composition which is suitable for adhering to polar substrates, specifically to polyamides (PA). This document discloses providing, in addition to a TPOE (blend of a thermoplastic polyolef in resin and a rubber such as EPDM) or a STPE (styrene-based thermoplastic elastomeric block copolymer), 2 to 60 wt. % of an adhesion promoter, which is intended to be a reaction product of a polyamide and a functionalised rubber. In this case, the functionalised rubber is a styrene-based block copolymer or an EAM or EADM rubber. Adhesion is promoted in this case in accordance with the principle of physical adhesion, according to which like dissolves like.

The object of the present invention is therefore to provide a TPE, in particular a TPE-V and a TPE-O, which can be used to attain particularly effective adhesion to polar substrates, without the substrate surface having to be pretreated and without the need for an intermediate coating.

This object is achieved by an olefinic thermoplastic elastomer composition which comprises a cross-linkable rubber component, a polyolefin and an adhesion promoter system, the adhesion promoter system comprising in turn one or more first adhesion promoters from the group of wetting adhesion promoters and one or more second adhesion promoters from the group of chemically reactive adhesion promoters.

Surprisingly, adding a combined adhesion promoter system consisting of adhesion promoters having a wetting action and chemically reactive adhesion promoters has resulted in TPE that has been adhesion-modified in this manner adhering to polar substrates in a very effective manner even in each of the following processing methods: compression moulding, co-moulding, overmoulding, co-extrusion or injection moulding, the good mechanical and resilient properties of the modified TPE remaining unchanged. The combination of the two adhesion mechanisms according to the invention, “chemical bonding” and “physical adhesion”, results in very durable and strong adhesion between the TPE-Vs according to the invention and the polar substrates. The polar substrates to be coated no longer have to be pretreated and the use of additional adhesives, such as coatings, can likewise advantageously be dispensed with.

In this respect, it is important to select a combination of one to four adhesion promoters from the group of wetting adhesion promoters in order to create optimum surface contact, in terms of both area and spacing. By optimally utilising the surface, mechanical anchorage generated by utilising the unevenness of the substrate surface can be improved. Owing to the very effective wetting according to the invention, the spacing between the substrate and the TPE can also be reduced, and therefore the physical and chemical bonds can be formed in a strengthened manner. Finally, as a result of the large contact area between the substrate and the TPE made possible by effective wetting, the number of bonds can be increased too.

In this respect, it is equally important to also select a combination of one to four adhesion promoters from the group of chemically reactive adhesion promoters and to add the two groups to the TPE such that adhesion by chemical bonding is also made possible. These second adhesion promoters have one or more of the same or different chemically active functional groups that are suitable for a reaction with the functional groups of the polar substrates. In this case, depending on the adhesion promoter, some may also act additionally as wetting components.

Surprisingly, this type of adhesion promotion can be universally transferred to all cross-linking systems and un-crosslinked TPE-O, without this being detrimental to the adhesive properties. Furthermore, surprisingly, it has been found that the concept of adhesion promotion according to the invention can be adjusted, regardless of the hardness rating, over a very wide hardness range, specifically from Shore A 30 to Shore D 60, by varying the proportion of polypropylene to rubber and plasticiser oils, without this being detrimental to the adhesive properties.

### DETAILED DESCRIPTION OF THE INVENTION

The olefinic thermoplastic elastomer composition comprises a rubber component, a polyolefin and an adhesion promoter system, the adhesion promoter system comprising in turn one or more first adhesion promoters from the group of wetting adhesion promoters and one or more second adhesion promoters from the group of chemically reactive adhesion promoters. In this case, the rubber component is in particular cross-linkable in the case of TPE-V.

According to the invention, the thermoplastic polyolef in component is a thermoplastic crystalline or semi-crystalline polyolefin homopolymer and/or a thermoplastic crystalline or semi-crystalline polyolef in copolymer, the mono-olefin monomer of which comprises 2 to 7 carbon atoms; the monomer is in particular selected from: ethylene, propylene, 1-butene, isobutylene, 1-pentene, 1-hexene, 1-octene, 3-methyl-1-pentene, 4-methyl-1-pentene and 5-methyl-1-hexene. The mono-olefin monomer preferably comprises 3 to 6 carbon atoms, and is particularly preferably propylene.

The in particular cross-linkable rubber component is selected from: the terpolymer rubbers of ethylene, propylene and a non-conjugated diene (EPDM) and/or copolymers, for example ethylene propylene rubber (EPR), ethylene/α-olefin copolymer rubber (FAM) or ethylene/α-olefin/diene terpolymer rubber (EADM).

The adhesion promoter system necessarily comprises two types of adhesion promoters:

The group of adhesion promoters that provide for optimum wetting includes ionomers and ethylene vinyl-acetate rubber (EVM) having various vinyl acetate contents and comprising maleic anhydride-grafted polymers, polypropylene, polyethylene, polypropylene-polyethylene copolymers, poly-α-olefins, ethylene-propylene-diene rubbers (EPDM) and polyam ides forming the polymeric backbone thereof.

The group of adhesion promoters that provide for a chemical reaction between the TPE and the substrate is formed of adhesion promoters comprising one of the following functional groups: anhydride, epoxide, silane and esters thereof, carboxyl group, ester group and acid chloride. Coupling agents from the group of maleic anhydride-grafted polymers are particularly suitable, the polymeric backbone thereof being formed by polypropylene, polyethylene, polypropylene-polyethylene copolymers, poly-α-olefins, ethylene-propylene-diene rubber (EPDM), polyamides, graftable siloxanes, vinyl siloxanes and esters thereof, epoxides such as chain extenders, or epoxy or glycidyl compounds.

The adhesion promoter system comprises two to eight, in particular two to six, particularly preferably two to four, adhesion promoters, at least one of which belongs to one of the two required adhesion promoter groups and at least one other of which belongs to the other of the two required adhesion promoter groups, as already mentioned. Preferably, there are the same number of each of the two adhesion promoters groups; however, this is not absolutely necessary. According to the invention, the adhesion promoter system content of the composition is between 0.5 and 25 wt. %, preferably between 1.0 and 15 wt. %, particularly preferably between 1.5 and 10 wt. %. According to the invention, in this respect, the content of an adhesion promoter group is no lower than 0.5 wt. %.

Furthermore, the composition according to the invention may contain one or more additives, selected from reinforcing and non-reinforcing fillers, processing oils, diluting or extending oils, plasticisers, waxes, stabilisers, oxidation inhibitors, cross-linking agents, processing aids, internal and external lubricants, pigments and colouring agents. The cross-linking agents may be for example phenol resin-based cross-linking agents having, as the initiator, tin salts, for example tin halides or tin halide batches that may or may not contain water of crystallisation, and having metal oxides, for example calcium oxide, magnesium oxide and zinc oxide, as the retarder.

The cross-linking agents may also be organic peroxide-based cross-linking agents and one to three co-agents such as modified acrylates, methacrylates, isourates or cyanurates, polybutadienes, dimaleimides and the like, for example N,N′-m-phenylenedimaleimide, zinc diacrylate, triallyl isocyanurate (TIAC), triallyl cyanurate (TAC), trimethylolpropane triacrylate (TMPTA), trimethylolpropane trimethacrylate (TRIM), 1,2-polybutadiene such as liquid polybutadiene (Ricon 153) or solid syndiotactic polybutadiene, polysiloxane containing vinyl, propyl or ethoxy groups, and the like. Peroxides are in particular di-t-butyl peroxides, dicumyl peroxides, di(t-butylperoxyisopropyl)benzene, 2,5-dimethyl-2,5-di-(t-butylperoxy)hexane, 2,5-dimethyl-2,5-di-(t-butylperoxy) hexyne and 3,3,5,7,7-pentamethyl-1,2,4-trioxepane. TPE-Os do not require any cross-linking agents. Other additives may be phenol resins having a percentage by weight of 0.01 wt. % to 15 wt. %, tin halides having a percentage by weight of 0.01 wt. % to 5 wt. % and metal oxides having a percentage by weight of 0 wt. % to 3 wt. %. Other additives, including fillers as described in “Rubber World Magazine Blue Book” and in “Zweifel et al., Plastics Additives Handbook, Hanser 2009”, are explicitly included here in the disclosure.

Fillers and extenders include conventional inorganic substances such as calcium carbonate, clays, silica, talcum, titanium dioxide and carbon black. In this case, the fillers can in particular have a plurality of additive effects. In general, the rubber processing oils that are suitable are paraffinic, naphthenic or aromatic oils derived from petroleum fractions. The type of the selected oil can be one which is usually used in combination with the specific rubber(s) of the present composition. These additives can comprise a significant amount of the formulated total composition.

In addition to glass, steel, metals, polar polymers such as polyamides, above all, suitable technical resins may also be considered as polar substrates. In particular, the invention is suitable for coating various polyamides, for example unfilled polyamide 6, unfilled polyamide 66, filled polyamide 6 and filled polyamide 66, boron glasses, quartz glasses, glasses, metals such as aluminium, iron or copper, and metal alloys such as stainless steel, steel, V2A-steel, brass or bronze.

The thermoplastic elastomer composition of the present invention can be applied to the substrate using various different methods and, owing to its composition, generates adhesion without any further special pretreatment of the surface. The surface of the substrate is optionally kept oil-free and/or is heated.

### Examples

Where the sum of the percentages does not equal 100% in the following examples, one or more of the above-mentioned additives make up the remaining percentage.

Example 1: a thermoplastic elastomer composition according to the invention is composed of 20% PP, 40% EPDM, 10% fillers and 20% oil. It also contains 4% PP-g-MAH and 2% EPR-G-MAH. The cross-linking system is a phenolic cross-linking system. Example 1 has a Shore hardness of 40 D, a peel strength of 815 N on aluminium, 830 N on stainless steel and 780 N on steel. The failure mode is a cohesive failure mode on aluminium and a peel failure mode on the other two materials.

Example 2: a thermoplastic elastomer composition according to the invention is composed of 20% PP, 37% EPDM, 10% fillers and 20% oil. It also contains 6% PP-g-MAH and 3% ionomer. The cross-linking system is a phenolic cross-linking system. Example 2 has a Shore hardness of 40 D, a peel strength of 812 N on aluminium, 793 N on stainless steel and 822 N on steel. The relevant failure mode is a cohesive failure mode.

Example 3: a thermoplastic elastomer composition according to the invention is composed of 90.5% TPE-V. It also contains 7% PP-g-MAH and 2.5% ionomer. The cross-linking system is second extrusion. Example 3 has a Shore hardness of 50 A, a peel strength of 226 N on aluminium, 258 N on stainless steel and 253 N on steel. The relevant failure mode is a cohesive failure mode.

Example 4: a thermoplastic elastomer composition according to the invention is composed of 90% TPE-V. It also contains 6% PP-g-MAH and 4% EPR-g-MAH. The cross-linking system is second extrusion. Example 4 has a Shore hardness of 50 A, a peel strength of 258 N on aluminium, 231 N on stainless steel and 258 N on steel. The relevant failure mode is a cohesive failure mode.

Example 5: a thermoplastic elastomer composition according to the invention is composed of 7% polypropylene, 54% EPDM, 10% fillers and 17% oil. It also contains 4.5% PP-g-MAH and 4.5% EPR-g-MAH. The cross-linking system is a phenol resin. Example 5 has a Shore hardness of 55 A, an ultimate elongation of 260%, a σ max of 4.1 MPa, a density of 0.961 g/cm³, a peel strength of 67 N. The failure mode is a cohesive failure mode.

Example 6: a thermoplastic elastomer composition according to the invention is composed of 9% polypropylene, 56% EPDM, 10% fillers and 12% oil. It also contains 5% PP-g-MAH and 5% EPR-g-MAH. The cross-linking system is a peroxide. Example 6 has a Shore hardness of 55 A, an ultimate elongation of 400%, a σ max of 5.1 MPa, a density of 0.940 g/cm³, a peel strength of 84.6 N. The failure mode is a cohesive failure mode.

Example 7: a thermoplastic elastomer composition according to the invention is composed of 8% polypropylene, 49% EPDM, 9% fillers and 22% oil. It also contains 5% PP-g-MAH and 5% EPR-g-MAH. The cross-linking system is a peroxide. Example 6 has a Shore hardness of 55 A, an ultimate elongation of 480%, a σ max of 4.3 MPa, a density of 0.913 g/cm³, a peel strength of 81.5 N. The failure mode is a cohesive failure mode.

Example 8: the last example is composed of 40% polypropylene, 42% EPDM and 10% fillers. It also contains 5% PP-g-MAH and 2.5% ionomer. Example 12 has a Shore hardness of 40 D, a peel tensile strength of 354 N on aluminium, 608 N on stainless steel, 576 N on steel and 391 N on galvanised steel.

A comparative example uses Santoprene 191-55PA. The cross-linking system is a phenol resin. Comparative example 7 has a Shore hardness of 55 A, an ultimate elongation of 290%, a σ max of 2.9 MPa, a density of 0.950 g/cm³, a peel strength of just 34.0 N. The failure mode is a debonding failure mode.

The TPE-Vs according to the invention are produced in mixing units such as single-screw extruders, twin screw extruders, Banbury mixers or the like. They are produced either in one step in which the adhesion promoter combination is added into the mixing unit during the cross-linking step or alternatively in a plurality of steps, the finished TPE-V being subsequently adhesion-modified in the mixing units.

Using the preparation according to the invention, adhesion can be generated in one or more steps, without pretreating the polar surfaces. The finished adhesion-modified compound is sprayed directly onto a polar substrate by means of an injection-moulding machine, which substrate may be heated, in particular up to >50° C. Direct co-extrusion, two-component injection moulding (also referred to as overmoulding) and co-moulding applications are also possible, it also being possible to injection-mould sheets or complex geometries in a preliminary step without any adhesive bonds in the mould and to subsequently press said sheets or complex geometries against polar substrates such as metal or glass components. Using commonly used pressing methods, such as hydraulic pressing, it is possible to obtain durable solid metal-TPE-V composite parts and metal-TPE-V-metal sandwich structures in short pressing times, even using two different metals, such as steel and aluminium. Therefore, processing is not limited to melting processes.

The invention also makes it possible to form sandwich structures from two different metals such as steel and aluminium by means of a TPE-V intermediate layer, and this creates new and versatile possibilities in lightweight construction; it is in particular possible to produce new components in the automotive industry, in shipbuilding and in the electrical/electronics industry, which components are metal polymer composites. Other fields in which the invention can be used are the building and construction industry, office supplies, household goods, cosmetics, generally in machine building, medical technology, the pharmaceutical industry, the furniture industry, the packaging industry and also in the sports and leisure industry. In other words, the invention can be used in any field in which good adhesive properties are required and in which it is useful to use metal polymer composites.

According to the invention, the finished adhesion-modified compound can in this case be applied directly to a polar substrate by means of an injection-moulding machine (SGM), the surface temperature of which substrate should be >50° C. in the case of polymer substrates. In the case of metals, metal alloys and/or blends, the surface temperature should be >60° C.; this temperature can be reached using water or oil thermostats, induction heating, etc. Inorganic substrates such as sheet steel have to be oil-free.

The application can also be achieved by co-extrusion when the adhesion-modified TPE-V is applied to a heated polar substrate; for metals, the same restrictions apply as those in injection-moulding methods.

However, processing is not limited to melting processes; sheets and other geometries can also be injection-moulded in a preliminary step without adhesion in the moulds and adhesively pressed together with polar substrates, which in this case are intended to predominantly be metal components, by means of pressing processes in commonly used presses, e.g. hydraulic presses, within the shortest possible time period. In this case too, only the metal parts have to be oil-free. Solid metal-TPE-V composite parts are formed by the pressing process in this case, it also being possible to produce metal-TPE-V-metal sandwich structures, even using two different types of metal, e.g. steel-TPE-V-aluminium composites.

The hardness of the modified TPE-V can be in the range of from A 30 to D 60, without this causing the adhesion forces to be reduced as a result of changes to the formulation.

1-11. (canceled)

12. Olefinic thermoplastic elastomer composition comprising a rubber component and a polyolefin, further comprising an adhesion promoter system which in turn comprises one or more first adhesion promoters from the group of wetting adhesion promoters and one or more second adhesion promoters from the group of chemically reactive adhesion promoters and one or more additives, selected from reinforcing and non-reinforcing fillers, processing oils, diluting or extending oils, plasticisers, waxes, stabilisers, oxidation inhibitors, cross-linking agents, processing aids, internal and external lubricants, pigments and colouring agents, wherein the thermoplastic polyolefin component is a thermoplastic crystalline or semi-crystalline polyolefin homopolymer and/or a thermoplastic crystalline or semi-crystalline polyolefin copolymer, the mono-olefin monomer of which comprises 2 to 7 carbon atoms, selected from: ethylene, propylene, 1-butene, isobutylene, 1-pentene, 1-hexene, 1-octene, 3-methyl-1-pentene, 4-methyl-1-pentene and 5 methyl-1-hexene, wherein the rubber component is selected from: the terpolymer rubbers of ethylene, propylene and a non-conjugated diene (EPDM) and/or a copolymer, specifically ethylene propylene rubber (EPR), ethylene/α-olefin copolymer rubber (FAM) or ethylene/α olefin/diene terpolymer rubber (EADM), wherein the group of wetting adhesion promoters is formed of ionomers, wherein the group of chemically reactive adhesion promoters is formed of maleic anhydride-grafted polymers, wherein the polymeric backbone thereof is formed by polypropylene, polyethylene, polypropylene-polyethylene copolymers, poly-α-olefins, ethylene-propylene-diene rubber (EPDM) and polyamides and is formed of graftable siloxanes, epoxides or epoxy or glycidyl compounds, wherein the adhesion promoter system content of the composition is between 1.5 and 10 wt. %.

13. Olefinic thermoplastic elastomer composition according to claim 12, characterised in that the mono-olefin monomer of the thermoplastic polyolefin component comprises 3 to 6 carbon atoms and is preferably propylene.

14. Olefinic thermoplastic elastomer composition according to claim 12, characterised in that the adhesion promoter system comprises two to eight, in particular two to six, particularly preferably two to four, adhesion promoters.

15. Method for producing an adhesion-modified TPE-V or TPE-O according to claim 1 in one step in which the adhesion promoter combination is added during the cross-linking step or in a plurality of steps in which the finished TPE-V compound is only subsequently adhesion-modified by means of mixing units such as single-screw extruders, twin screw extruders or Banbury mixers.

16. Use of an adhesion-modified TPE-V or TPE-O according to claim 1 for producing components in the automotive industry, shipbuilding, machine building, the electrical/electronics industry, the building and construction industry, medical technology, the pharmaceutical industry, the furniture industry, the packaging industry, the sports and leisure industry and in the field of office supplies, household goods and cosmetics, in order to produce metal polymer composites.
